(19) United States
(12) Patent Application Publication
(10) Pub. No.: US 2026/0244197 A1
(43) Pub. Date: Aug. 20, 2026

(54) PROCESS CONTROL SYSTEM AND METHOD

(71) Applicant: Hitachi, Ltd., Tokyo (JP)

(72) Inventors: Yohei KONO, Tokyo (JP); Taichi ISHITOBI, Tokyo (JP)

(21) Appl. No.: 19/153,715

(22) PCT Filed: Apr. 5, 2024
(86) PCT No.: PCT/JP2024/014039

§ 371 Date: Aug. 5, 2025

(30) Foreign Application Priority Data
Apr. 17, 2023 (JP) 2023-067400

(51) Int. Cl. G05B 19/418

(52) U.S. Cl. CPC G05B 19/41885; G05B 2219/32359

(57) ABSTRACT

Provided is a process control system capable of efficiently obtaining operating conditions suitable for a target process. A process control system that controls a target process by a computer includes: a process model storage section that stores a process model for predicting a control value from a manipulation value to the process; a manufacturing performance data storage section that stores manufacturing performance data on the process; a process simulation section that performs a simulation of the target process by using the process model acquired from the process model storage section; and an operating condition search section that extracts manufacturing performance data in another process similar to the target process within a predetermined range from the manufacturing performance data storage section, and searches for, based on the manufacturing performance data extracted, an operating condition that satisfies an operating restriction of the target process.

### TECHNICAL FIELD

The present disclosure relates to a process control system and method.

### BACKGROUND ART

In the site of process operation such as petrochemical plants, optimal process operating conditions (such as the time profile of temperature) for achieving the desired quality and yield are determined in advance from the performance records of test operation, past operation data, and the like, and during operation, control equipment such as valves is operated to reproduce those operating conditions. In general, such control is performed in a framework (model-based control) in which a process model representing the mass balance and energy balance of a process is used to estimate or predict the state of the process (temperature, substance concentration, and the like), and a manipulation value is determined based on the estimation or prediction result.

The mass balance and energy balance of a process may differ for each operation of the process. The reason for this is, for example, that various disturbances, such as differences in reaction heat due to differences in product types, differences in characteristics of control equipment such as valves, plant aging, and external environmental conditions that are not input, differ for each operation, and hence, the operation method for achieving the same operating conditions differ each time.

Such differences often occur in batch processes in which different product types may be manufactured with different types of equipment for each manufacturing unit (batch). Accordingly, in the control of batch processes, the parameters of the process model are changed depending on the types of equipment and products, and are used for control.

However, in the control of batch processes, the operating conditions of the process are not established in the first place depending on equipment types or product types, and the framework of model-based control cannot be applied in some cases. For example, in a case where there is no performance record of test operation or manufacturing with the same combination of a product type and an equipment type as in a control target batch, it is unknown what operating conditions are set to improve quality and yield. Moreover, it is also unknown whether the set operating conditions can comply with the operating restrictions of the plant. Moreover, even in a case where there are test operation performance records or manufacturing performance records, the user needs to intervene manually when the operating restrictions of the plant are violated. Where there is only performance data with manual intervention by the user, it is unknown whether the operating conditions corresponding to that performance data can be used as they are to comply with the operating restrictions. That is, in the case of a batch process with no performance record, it is required to search for operating conditions, which can at least comply with the operating restrictions of the plant, while considering differences in mass balance and differences in energy balance due to differences in equipment types or product types.

As a related art for searching for operating conditions, for example, there is Patent Literature 1. In Patent Literature 1, for searching for operating conditions, an optimization device with high simulation accuracy, which is capable of shortening the time for optimization calculation, is provided. In Patent Literature 1, based on data given regarding a control target, the feasible region within the search space is estimated, a polynomial model corresponding to the estimated feasible region is created, and a given objective function is optimized using that polynomial model, to thereby obtain a first optimal solution in the polynomial model. Based on this first optimal solution, the given objective function is optimized using a strict process model, which is a control target, thereby obtaining a second optimal solution.

### PRIOR ART LITERATURE

### Patent Literature

Patent Literature 1 : JP-2019-220028-A

### SUMMARY OF THE INVENTION

### Problem to be Solved by the Invention

In Patent Literature 1, a polynomial model for estimating a feasible region is constructed from performance data. However, as described above, in batch processes for manufacturing various types of products, there are cases where, in the first place, there may be no performance record of manufacturing with the same product type and the same equipment type as in a control target batch, and without user manual intervention.

In a case where there is no reliable performance data, it is impossible to construct a polynomial model using performance data on a process having the same characteristics as in a control target. Even if the technology of Patent Literature 1 is applied using performance data on another process, the estimated feasible region does not reflect the actual characteristics of the control target. Therefore, even if the control target is operated under the operating conditions obtained through optimization, there is no guarantee that the operating restrictions can be complied with.

A method in which test operation is performed in advance to collect data for estimating a feasible region can also be considered. In general, however, the test operation of a plant is performed through trial and error so as not to infringe the operating restrictions, and hence the test operation requires several weeks to several months. That is, it is not realistic from the viewpoint of lead time to perform test operation every time to search for new operating conditions.

Therefore, there is a demand for a technology for obtaining, even in a case where there is no performance data on a process having the same characteristics as in a control target, operating conditions that can comply with operating restrictions within a feasible time.

The present disclosure provides a process control system capable of efficiently obtaining operating conditions suitable for a target process.

### Means for Solving the Problem

To solve the above-mentioned problems, a process control system according to one aspect of the present disclosure is a process control system configured to control a target process by a computer, including: a process model storage section that stores a process model for predicting a control value from a manipulation value to the process; a manufacturing performance data storage section that stores manufacturing performance data on the process; a process simulation section that performs a simulation of the target process by using the process model acquired from the process model storage section; and an operating condition search section that extracts manufacturing performance data in another process similar to the target process within a predetermined range from the manufacturing performance data storage section, and searches for, based on the manufacturing performance data extracted, an operating condition that satisfies an operating restriction of the target process.

### Advantages of the Invention

According to the present disclosure, it is possible to search for, using manufacturing performance data on other processes similar to a target process, operating conditions that satisfy the operating restrictions of the target process.

### BRIEF DESCRIPTION OF THE DRAWINGS

FIG. 1 is an overall diagram of a process control system of the present embodiment.

FIG. 2 is a hardware configuration diagram of a computer that can be used in the process control system.

FIG. 3 is an example of manufacturing performance data.

FIG. 4 is an example of the parameters of a process model.

FIG. 5 is an example of a control law.

FIG. 6 is a flowchart of the processing of generating the process model.

FIG. 7 is a flowchart illustrating the procedure for manufacturing while controlling a process by the process control system.

FIG. 8 is a flowchart illustrating the details of operating condition candidate extraction processing that is performed in Step S300 in FIG. 7.

FIG. 9 illustrates an example of an operating condition candidate extraction screen that is provided to a user in Step S300 in FIG. 7.

FIG. 10 is a flowchart illustrating inter-process model distance calculation processing that is performed in Step S305 in FIG. 8.

FIG. 11 is a flowchart illustrating operating condition search processing that is performed in Step S400 in FIG. 7.

FIG. 12 illustrates the details of Step S402 in FIG. 11.

FIG. 13 illustrates the details of Step S406 in FIG. 11.

FIG. 14 is an example of an operating condition search screen that is provided to the user in Step S400 in FIG. 7.

FIG. 15 is an example of a screen indicating the search result of operating conditions, which is provided to the user in Step S406 in FIG. 11.

FIG. 16 is a flowchart illustrating the processing of acquiring manufacturing performance data according to a second embodiment.

FIG. 17 is a flowchart illustrating the processing of acquiring the product type of a manufacturing target and an equipment type to be used for manufacturing according to a third embodiment.

### MODES FOR CARRYING OUT THE INVENTION

Now, embodiments of the present disclosure are described based on the drawings. In the following, the embodiments of the present disclosure are described with reference to the drawings. In the following description and the drawings, which are examples for describing the present disclosure, for clarity of description, omission and simplification are made as appropriate. The present disclosure can also be implemented in various other forms. Unless particularly limited, the number of each component may be one or plural.

The positions, sizes, shapes, ranges, and the like of the respective components illustrated in the drawings do not represent the actual positions, sizes, shapes, ranges, and the like in order to facilitate understanding of the invention in some cases. The present disclosure is not necessarily limited to the positions, sizes, shapes, ranges, and the like disclosed in the drawings.

In the following description, various types of information may be described by expressions such as “database,” “table,” and “list,” but the various types of information may also be expressed by data structures other than these. To indicate independence from data structures, “XX table,” “XX list,” and the like may be referred to as “XX information.” When identification information is described, in a case where expressions such as “identification information,” “identifier,” “name,” “ID,” and “number” are used, these can be replaced with each other.

In a case where there are a plurality of components having the same or similar functions, different subscripts are attached to the same reference numeral for description in some cases. However, in a case where there is no need to distinguish between the plurality of components, the subscripts are omitted in the description in some cases.

In the following description, processing that is performed through the execution of a computer program is described in some cases. The computer program is executed by a processor (for example, a CPU (Central Processing Unit) or a GPU (Graphics Processing Unit)) to perform defined processing appropriately using storage resources (for example, memory) and/or interface devices (for example, communication ports), for example, and hence the processor may be regarded as the subject of the processing. Similarly, the subject of processing that is performed through the execution of the computer program may be a controller, a device, a system, a calculator, or a node, each of which includes a processor. The subject of processing that is performed through the execution of the computer program is only necessary to be an arithmetic section and may include a dedicated circuit performing specific processing (for example, an FPGA (Field-Programmable Gate Array) or an ASIC (Application Specific Integrated Circuit)).

The computer program may be installed from a program source into a device such as a calculator. The program source may be, for example, a computer program distribution server or a storage medium readable by a calculator. In a case where the program source is a program distribution server, the program distribution server may include a processor and storage resources storing programs to be distributed, and the processor of the program distribution server may distribute the programs to be distributed to other calculators. Furthermore, in the following description, two or more programs may be achieved as one program, or one program may be achieved as two or more programs.

In a process control system of the present disclosure, even in a case where there is no performance data on normal manufacturing in a control target, appropriate operating conditions are generated from past manufacturing performance data, and the process is controlled using the generated operating conditions to manufacture products.

The process control system according to the present disclosure searches for operating conditions suitable for the characteristics of the control target by a computer, and performs control under those operating conditions. The process control system includes a processing section that searches for, using the process model corresponding to the characteristics of the control target and a control law that is an algorithm for actually defining a manipulation value, operating conditions that comply with the operating restrictions.

According to one aspect of the present disclosure, there are provided effects such as making it possible to efficiently find, even in a case where there is no performance data on a process having the same characteristics as in the control target, operating conditions that can comply with the operating restrictions, thereby reducing manufacturing lead time, improving yield, and reducing manual intervention.

The present disclosure can be used for plants that manufacture chemical products or pharmaceuticals, for example, but can also be applied to various other plants, such as power generation plants, steel plants, and water treatment plants.

### Embodiment 1

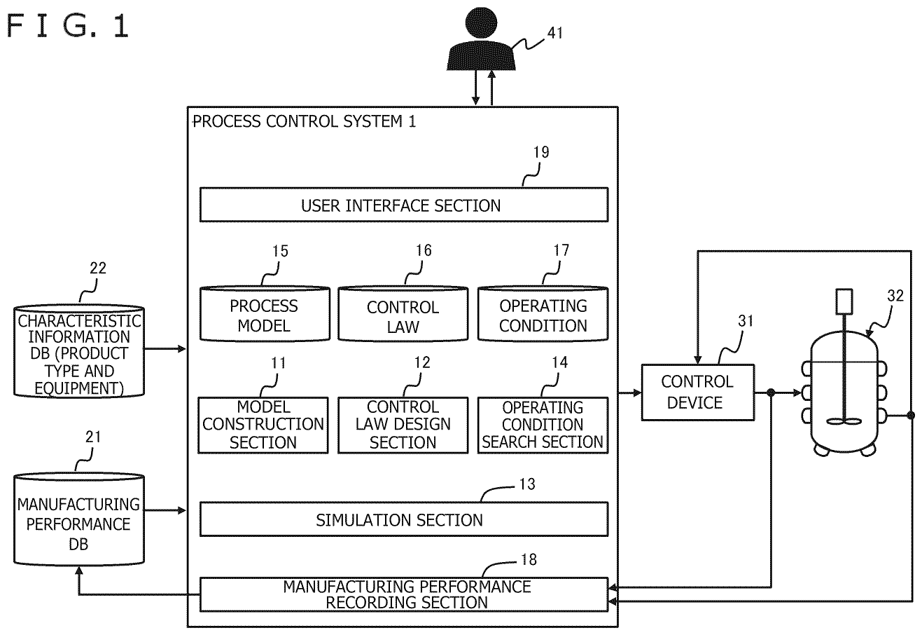

A first embodiment is described using FIG. 1 to FIG. 15. Now, embodiments of a process control system and a process control method according to the present embodiment are described in detail.

FIG. 1 illustrates a configuration example of a process control system 1 in Embodiment 1. The process control system 1 includes, for example, a model construction section 11, a control law design section 12, a simulation section 13, an operating condition search section 14, a process model 15, a control law 16, and a user interface section 19, each of which is described later.

The control system 1 is connected to a manufacturing performance database 21 that stores manufacturing performance data, and a characteristic information database 22 that stores characteristic information, and can send and receive data to and from those databases 21 and 22. The characteristic information refers to information about the product types of manufacturing targets (product type information), information about each piece of equipment to be used for manufacturing (equipment type information), and the like. The manufacturing performance data refers to data with performance records of past manufacturing and includes combinations of product types and equipment types, the presence or absence of manual intervention, and the like.

In the following, the manufacturing performance data stored in the manufacturing performance database 21 is given a reference numeral 21 for description in some cases. Similarly, the characteristic information stored in the characteristic information database 22 is given a reference numeral 22 for description in some cases. A process model storage section that stores the process model 15 may be given a reference numeral 15. A control law storage section that stores the control law 16 may be given a reference numeral 16. An operating condition storage section that stores an operating condition 17 may be given a reference numeral 17.

The process control system 1 uses the process model 15 suitable for the characteristics of a control target to extract, from the manufacturing performance data, operating conditions in a process having characteristics closest to those of the control target, as a candidate set of operating conditions. The process control system 1 further performs a simulation using the process model and modifies the extracted candidate set of operating conditions so as to obtain simulation results that comply with the operating restrictions. With this, the process control system 1 sets operating conditions suitable for the characteristics of the control target and controls the control target under those operating conditions.

The control target is a target to be controlled by the process control system 1, such as control equipment that performs process operation. In the following, a description is made on the assumption that the control target is equipment such as a reactor used in chemical plants or the like, but the present disclosure is not limited thereto and can be applied to various types of equipment and devices other than plants that perform process operation.

A description is made on the assumption that the characteristic information 22 on the control target includes the type of equipment and the product type of products to be manufactured by the control target, but information other than these representing the characteristics of the control target may be defined as characteristics.

The characteristics refer to elements that affect the behavior of the process model, such as the product type of products to be manufactured by the control target through process operation, and equipment that performs process operation. The characteristic type represents, for example, the type of elements included in a certain type of characteristic. The combination of characteristics represents, for example, a combination of a plurality of types of characteristics.

The model construction section 11 generates the process model 15. The model construction section 11 constructs the process model 15 to be stored for controlling the control target that performs process operation on the basis of either or both of the manufacturing performance data 21 and the characteristic information 22. In the present embodiment, it is assumed that model construction processing has been performed in advance for each characteristic of the control target, and that a process model has been obtained for each characteristic of the control target.

The control law design section 12 generates the control law 16 to be stored, which is a logic for controlling the control target. It is assumed that, similar to the model construction section 11, a suitable control law has been obtained for each characteristic of the control target.

The simulation section 13 simulates the behavior of the control target. As simulation methods, there are two types: an open-loop simulation using only the process model 15, and a closed-loop simulation using the process model 15 and the control law 16. In the case of an open-loop simulation, a manipulation value to be given to the control target is input to the process model 15, thereby simulating the physical quantity of the control target. In the case of a closed-loop simulation, a calculation in which a manipulation value to be given to the control target is input to the process model 15 to obtain the physical quantity of the control target, and a calculation in which the physical quantity of the control target and the operating condition 17 are input to the control law 16 to obtain a manipulation value to be given to the control target are combined, to thereby perform a simulation. That is, in a closed-loop simulation as a whole, when the operating condition 17 and the initial state of the physical quantity of the control target are input, the physical quantity and manipulation value of the control target are simulated.

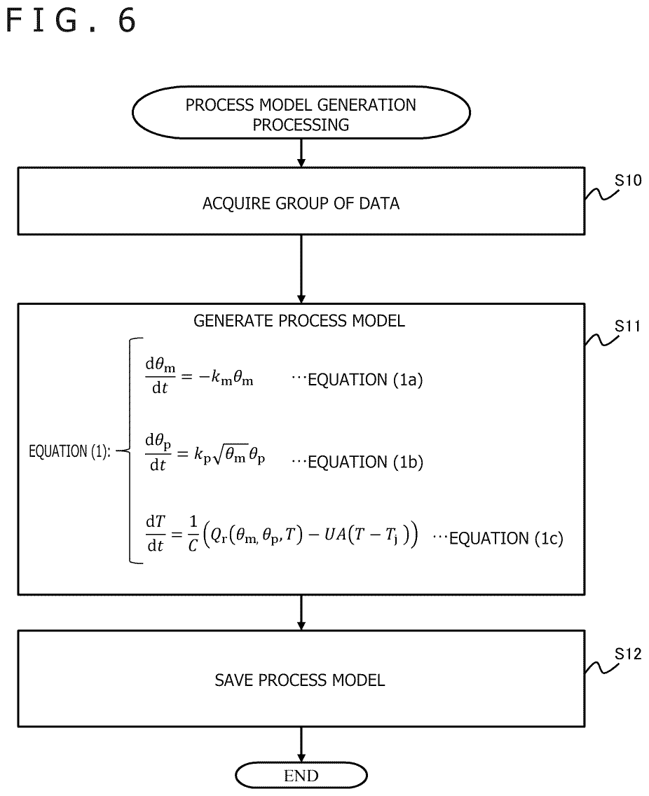

The process model 15 is a model in which the characteristics of the control target are modeled and is expressed by a mathematical expression constructed by theoretical equations such as the mass balance law, the energy balance law, or the reaction equation, or by a mathematical expression obtained by system identification or machine learning. In the following, a description is made using a model expressed by the differential equation indicated by Equation (1) described in Step S11 in FIG. 6.

Referring first to FIG. 6, a process model is generated in advance for each characteristic of the control target as described above. A process model generation device, which is not illustrated, acquires a group of data necessary for generating a process model (S10), generates a process model using the acquired group of data and the predetermined equation (1) (S11), and saves the generated process model (S12).

In Equation (1), θm represents the concentration of the raw material, θp represents the concentration of the product to be manufactured, T represents the reactor internal temperature, Tj represents the temperature of the coolant flowing through the jacket, and Qr represents the reaction heat. C is the heat capacity inside the reactor, U is the overall heat transfer coefficient of the jacket with the reactor, and A is the heat transfer area, all of which are parameters dependent on the equipment type. km and kp are the reaction rate constants, and Qr is the function of the reaction heat defined by the Arrhenius equation or the like, all of which are defined by the product type to be manufactured. The reactor internal temperature T and the coolant temperature Tj can be measured during operation, but the raw material concentration θm and the product concentration θp cannot be measured during operation. The raw material concentration θm and the product concentration θp are examples of internal states of the process, which are calculated without using actual measurement data.

The control law 16 has the function of obtaining, in the case of the above example, the coolant temperature Tj that keeps the raw material concentration θm, the product concentration θp, and the reactor internal temperature T at optimal operating conditions, using the model of Equation (1a) to Equation (1c). The control method may be a method in which a calculation is performed alone, such as so-called PID control, or may be a method in which a calculation is performed through internal execution of the process model 15, such as model predictive control (MPC).

The operating condition 17 is a condition that the state of the control target is to satisfy in order to keep the quality and the yield within a predetermined range.

For example, in the process represented by the model of Equation (1), the time series of the reference value of the reactor internal temperature T corresponds to the operating condition. In general, the operating conditions for manufacturing a certain product are obtained by performing test operation or trial production 4 the process with the reference value set to various time series patterns, and selecting the best time series pattern from the obtained quality and yield. That is, in a case where the characteristics of the process change greatly for each batch, it may possibly be necessary to redesign the operating conditions.

The user interface section 19 has the function of exchanging information with a user 41 who operates the process control system 1. Specifically, the user interface section 19 has the function of receiving parameters necessary for the series of processing processes that the process control system 1 performs (input), and the function of providing calculation results, control results, and the like (output function). With the input function, information is received from the user 41 using, for example, a keyboard, a touch panel, a voice input device, or a line-of-sight detection device. With the output function, information is provided to the user 41 using, for example, a monitor display, a printer, or a voice synthesis device. The user interface section 19 may be configured as a terminal separate from the main body of the process control system 1. For example, a personal computer of a laptop, notebook, tablet, or desktop type, a smartphone, or a wearable terminal of a goggle or wristwatch type can also be used as the user interface section 19.

The manufacturing performance storage section 18 generates the manufacturing performance data 21 including a time variation of a manipulation value input to a control target 32 and a control value detected from the control target, and stores the generated manufacturing performance data 21.

The control device 31 gives a manipulation value to the control target 32 in accordance with operating conditions calculated by the process control system 1, and controls the manipulation value based on a control value acquired from the control target 32.

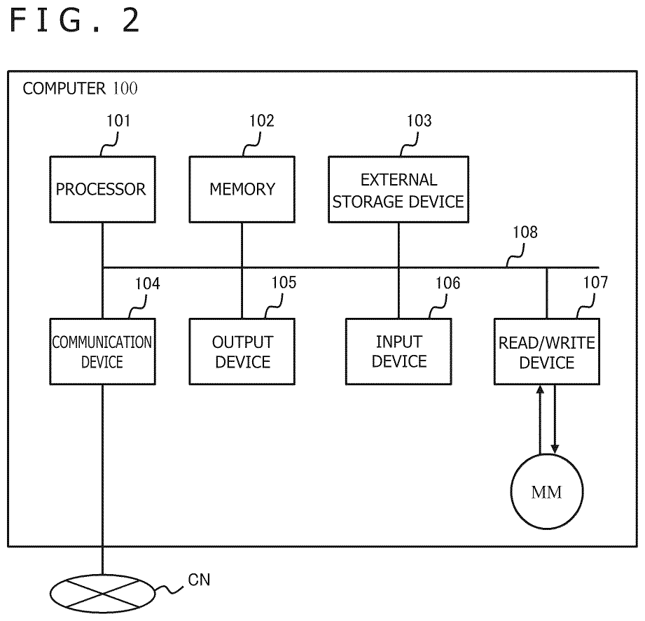

FIG. 2 is an example of a computer 100 that achieves the process control system 1. The computer 100 includes, for example, a processor 101, a memory 102, an external storage device 103, a communication device 104, an output device 105, an input device 106, and a read/write device 107. These respective circuits 101 to 107 are mutually connected via a communication line 108. The processor 101 is not limited to a CPU (Central Processing Unit) and may be another device having an arithmetic function. The external storage device 103 is, for example, a device that stores a relatively large amount of data in a rewritable manner, such as a hard disk device, a flash memory device, a magneto-optical disk device, or an optical disc device.

The communication device 104 is configured as a NIC (Network Interface Card) or the like and communicates with external devices via a communication network CN. The external devices are, for example, the control device 31, each of the storage units (databases) 21 and 22, and sensors, which are not illustrated. Moreover, for example, the process control system 1 is also capable of bidirectional communication with a production management system, which is not illustrated, and the like.

The output device 105 is a device to be used by the user interface section 19 and may be, for example, a monitor display or a printer. The input device 106 is a device to be used by the user interface section 19 and may be, for example, a keyboard, a pointing device, or a touch panel. The read/write device 107 reads and writes information to and from a memory medium MM that stores computer programs non-transitorily.

The communication line 108 may be a system bus that connects elements within a single computer, or may be a communication network that connects between a plurality of computers. That is, it is also possible to provide the main functions of the process control system 1 on a plurality of computers and mutually connect those computers via a communication network, thereby achieving the process control system 1.

The various types of data stored in or used for processing in the process control system 1 (for example, the process model 15, the control law 16, and the operating condition 17) can be achieved by the processor 101 reading and utilizing the data from the memory 102 or the external storage device 103. The respective functional sections of each system or device (for example, the model construction section 11, the control law design section 12, the simulation section 13, and the operating condition search section 14) can be achieved by the processor 101 loading a predetermined computer program stored in the external storage device 103 into the memory 102 and executing the computer program.

The predetermined computer program described above may be stored (downloaded) in the external storage device 103 from the memory medium MM through the read/write device 107, or from the network through the communication device 104, and then may be loaded into the memory 102 and executed by the processor 101. The computer program may be directly loaded into the memory 102 from the memory medium MM through the read/write device 107, or from the network through the communication device 104, and may be executed by the processor 101.

In the following, a case where the process control system 1 includes a certain single computer is exemplified, but all or some of these functions may be provided on one or a plurality of computers, such as clouds, in a distributed manner to communicate with each other via a network, thereby achieving similar functions. The specific processing that each section of the process control system 1 performs is described later using the flowcharts.

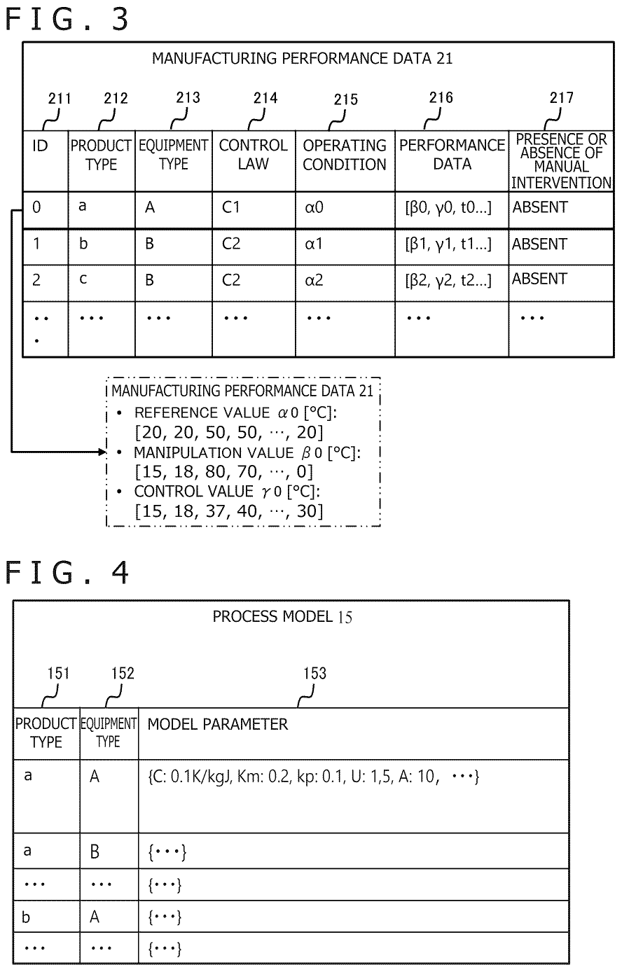

FIG. 3 illustrates an example of the manufacturing performance data 21. The manufacturing performance data 21 is data indicating past operation performance records obtained from the control target 32 and is input to the model construction section 11. As illustrated in FIG. 3, in the manufacturing performance data 21, a data ID 211 for identifying data, a product type 212 and an equipment type 213 indicating characteristics, a control law 214 and an operating condition 215 used in operation, performance data 216, and presence or absence of manual intervention 217 are stored in association with each other.

The performance data 216 includes, for example, operation information and measurement information on the control target forming the plant, and stores, for example, time series data including manipulation values and control values. The manipulation value is information indicating a control target operation method for achieving control based on the control value, and calculated by equipment, which serves as a control target, based on a reference value.

For example, a case is described where cold water is flowing through the jacket connected to the wall surface of the reactor, which is a control target, and the temperature is changed by changing the opening degree of the control valve causing cold water to flow. The control value is an operating condition of control to be actually performed by the control target, and is, for example, information indicating the actual temperature inside the reactor, which is a control target.

In FIG. 3, for example, manufacturing performance data identified by a data ID “0” includes manufacturing performance data 301 regarding a control target having characteristics represented by a product type “a” and equipment “A.” The reference value, the manipulation value, and the control value are stored as time series values at predetermined intervals (for example, every one minute), as a reference value α0 [C]: [20, 20, 50, 50, . . . 20], a manipulation value β0 [%]: [15, 18, 80, 70, . . . , 0], and a control value γ0 [C]: [15, 18, 37, 40, . . . 30], respectively. For example, in the reference value α0 of the equipment “A” for manufacturing a product of the product type “a,” temperature values such as 20° C., 20° C., 50° C., 50° C., . . . , 20° C. are stored every one minute. t0, t1, and t2 are time points at which data has been recorded.

FIG. 4 illustrates an example of the process model 15 and an example of the relationship between the process model and the characteristics. The process model 15 is represented as a model constructed by the predetermined theoretical equation (1) as described above. The process model 15 includes a product type 151, an equipment type 152, and a model parameter 153. In FIG. 4, a model represented by Equation (1) is exemplified as the process model 15. In this example, parameters C, km, kp, U, and A of the process model are given as 0.1, 0.2, 0.1, 1.5, and 10, respectively.

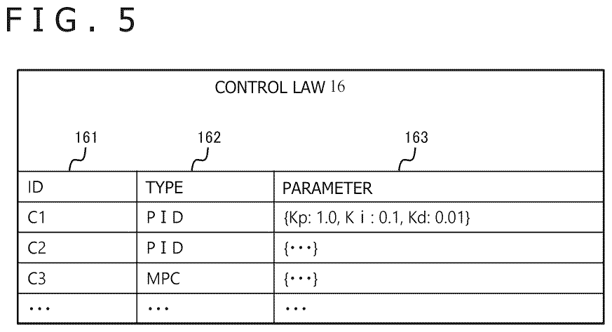

FIG. 5 illustrates an example of the control law 16. The control law 16 includes an ID 161 of the control law, a type 162 of the control law, and a parameter 163 for defining the control law. For example, a control law identified by a data ID “C1” is described as an example.

In this case, the type 162 of the control method is “PID control,” and in the parameter 163, “for proportional gain Kp, integral gain Ki, and derivative gain Kd, respectively, values such as 1.0, 0.1, and 0.01” are stored.

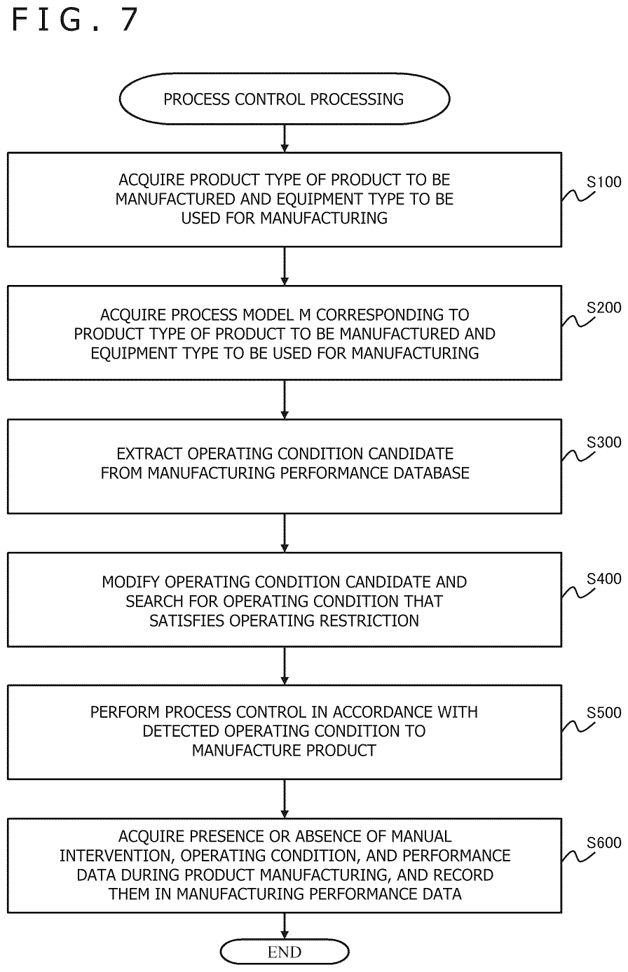

FIG. 7 illustrates the procedure for operating a process using the process control system 1 to manufacture a product.

The process control system 1 acquires a product type to be manufactured and an equipment type to be used for manufacturing, which are input to the user interface section 19 by the user 41 (S100).

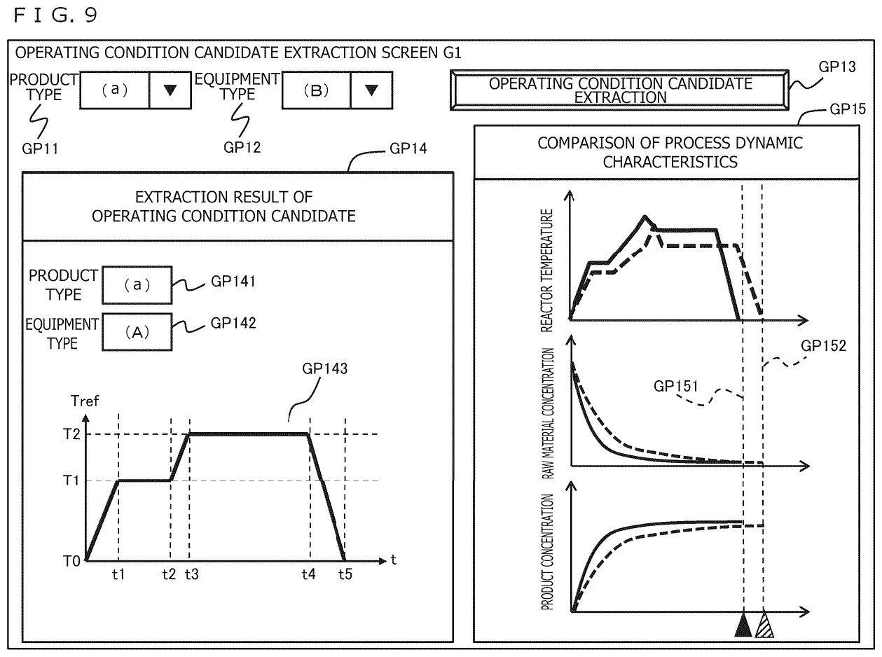

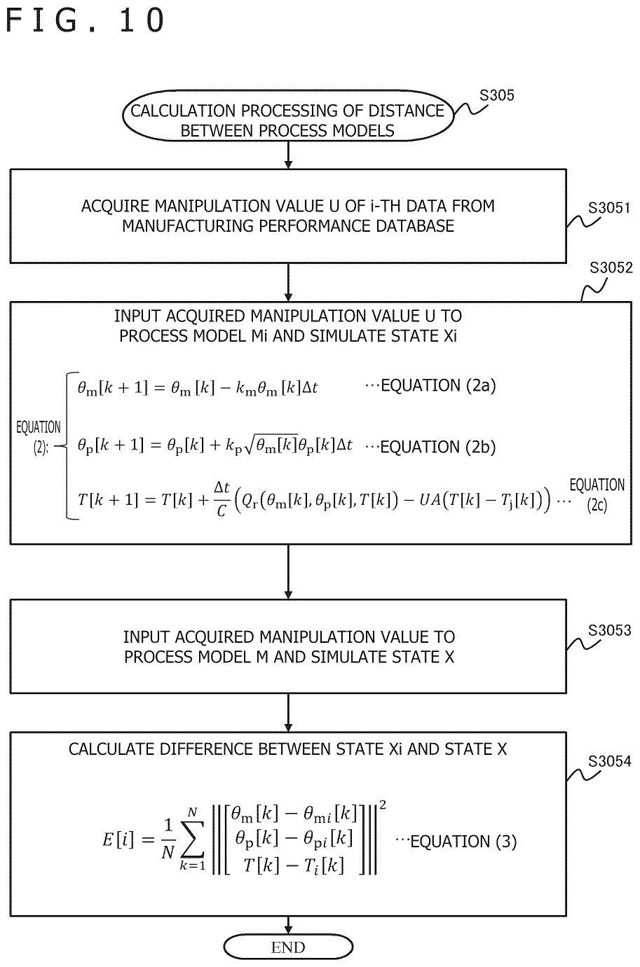

Reference is now made to FIG. 9. FIG. 9 is an example of a screen G1 for extracting candidate sets of operating conditions. The screen G1 for extracting candidate sets of operating conditions includes, for example, a field GP11 for selecting a product type, a field GP12 for selecting an equipment type, a button GP13 used for instruction on the extraction of candidate sets of operating conditions, a field GP14 for displaying the extraction results of candidate sets of operating conditions, and a field GP15 for comparing process dynamic characteristics.

In the field GP14 for displaying the extraction results of candidate sets of operating conditions, data on a process close to the target process is extracted and displayed. In a product type display section GP141, the product type of a comparison target process is displayed.

In an equipment type display section GP142, the equipment type of the comparison target process is displayed. In a field GP143 for displaying time patterns of operation data, for example, a time variation of a target temperature is displayed. In the case of pressure control, a time variation of a target pressure is displayed.

In the field GP15 for comparing process dynamic characteristics, the dynamic characteristics of the target process (solid line in the drawing) and the dynamic characteristics of the extracted comparison target process (dotted line in the drawing) are displayed in contrast. In the example of FIG. 9, as the process dynamic characteristics, for example, reactor temperature, raw material concentration, and product concentration are illustrated. Moreover, in the field GP15, a target process reaction endpoint GP151 and a comparison target process reaction endpoint GP152 are also displayed. Even in a case where the time point GP151 at which the reaction of the target process ends differs from the time point GP152 at which the reaction of the comparison target process ends, the processes can be compared through adjustment of the time axis as described later, for example.

Returning to FIG. 7, in Step S100, it is assumed that the user 41 selects a product type and an equipment type in the fields GP11 and GP12, respectively, and presses the operating condition candidate extraction button GP13.

The operating condition search section 14 acquires, from among the process models stored in the process model 15, a model M corresponding to the product type and equipment type input in Step S100 (S200).

The operating condition search section 14 acquires, from the manufacturing performance database 21, manufacturing performance data having dynamic characteristics closest to those of the model M, and extracts, as a candidate set of operating conditions, operating conditions in that manufacturing performance data (S300). Here, a model M′ having dynamic characteristics closest to those of the model M is acquired from the process model 15, and manufacturing performance data with the product type and equipment type corresponding to the model M′ is acquired. The dynamic characteristics represent a time variation in the state of the control target when a certain manipulation value is given, and details thereof are described later. The model M′ having dynamic characteristics closest to those of the target process model M corresponds to an example of “another process similar to a target process (target process model M) within a predetermined range.” Instead of the process model having the closest dynamic characteristics, a process model whose difference in dynamic characteristics is within a predetermined range may be extracted.

The operating condition search section 14 modifies the candidate set of operating conditions extracted in Step S300 and searches for operating conditions that maximize the KPI while complying with the operating restrictions (S400). Here, the operating restrictions include, for example, an upper limit value of reactor internal temperature or product concentration provided for safety. The KPI (Key Performance Indicator) corresponds to a “predetermined evaluation index.” The KPI is, for example, the manufacturing time per batch. If there are restriction conditions that the operating conditions are to satisfy to maintain quality, such as keeping the reaction time at or above a certain level, in addition to the operating restrictions, the operating conditions are searched for in a manner that also complies with those.

The process control system 1 acquires, from the control law 16, the control law corresponding to the product type and equipment type acquired in Step S100, and transmits the acquired control law and the operating conditions searched for in Step S400 to the control device 31. The control device 31 uses the control law and operating conditions received from the process control system 1 to control the control target 32, thereby manufacturing the specified product (S500).

At this time, the manipulation value and the actual measurement value of the control value have been transmitted to the control device 31. The control device 31 transmits the manipulation value and the actual measurement value of the control value to the manufacturing performance recording section 18. In FIG. 1, for the sake of description, it is illustrated as if the manipulation value is input from the control device 31 to the manufacturing performance recording section 18, and the actual measurement value of the control value is input from a sensor (not illustrated) provided in the control target 32 to the manufacturing performance recording section 18. However, in actuality, it is only necessary that the control device 31 transmit the manipulation value and the actual measurement value of the control value to the manufacturing performance recording section 18.

The manufacturing performance recording section 18 acquires the manipulation value and the actual measurement value of the control value and records the manufacturing performance data 21 based on these (S600). Here, the product type and equipment type 22 input in Step S100, the operating condition 17 searched for in Step S400, and the control law 16 acquired in Step S500 are recorded as manufacturing performance data in the format illustrated in FIG. 3, together with the manipulation value and the control value.

Moreover, the manufacturing performance recording section 18 determines, from the manipulation value and the actual measurement value of the control value, whether manual intervention has occurred due to, for example, violation of the operating restrictions of the plant, and records the presence or absence of manual intervention. For example, in a case where the time point at which the manipulation value is output and the time point at which the actual measurement of the control value occurs are not at fixed cycles and there is a non-measurement period, it can be determined that manual intervention has occurred.

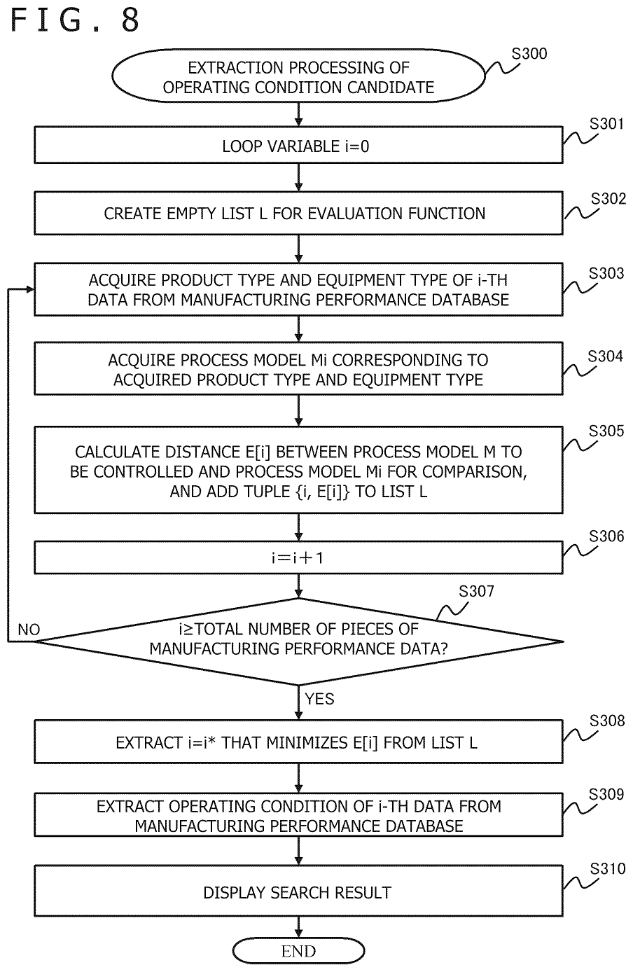

FIG. 8 is a flowchart illustrating the details of operating condition candidate extraction processing that is performed in Step S300 illustrated in FIG. 7. In Step S300, as described below, the degrees of similarity of dynamic characteristics between the process model M corresponding to the product type and equipment type of the control target and all the process models recorded in the process model 15 are evaluated, and from the manufacturing performance data corresponding to a process model with the minimum evaluation function, a candidate set of operating conditions is extracted.

The operating condition search section 14 sets a loop variable i to 0 (S301), creates an empty list L for the evaluation function (S302), and enters Loop 1 for evaluating the models. In Loop 1, the i-th product type and equipment type are acquired from the manufacturing performance data 21 (S303), a model Mi corresponding to the acquired product type and equipment type is acquired from the process model 15 (S304), a distance E[i] between the process model M and the process model Mi is calculated, and {i, E[i]} is added to the list L (S305). Then, the operating condition search section 14 increments the variable i by one (S306) and repeats the processing of Step S303 to Step S305 until the variable i reaches the number of pieces of manufacturing performance data or more (S307).

After “YES” is determined in Step S307 and Loop 1 is exited, the operating condition search section 14 extracts a variable i* that minimizes the distance E[i] from the list L (S308), extracts the operating conditions of the i *-th data from the manufacturing performance data 21, and regards the extracted operating conditions as a candidate set of operating conditions (S309).

Finally, the operating condition search section 14 causes the i*-th product type and equipment type and the time pattern of the candidate set of operating conditions to be displayed in the operating condition candidate extraction result display field GP14 in the screen G1 illustrated in FIG. 9. Moreover, the operating condition search section 14 causes a comparison between the dynamic characteristics of the control target process model M and the dynamic characteristics of a process model M* corresponding to the i *-th product type and equipment type to be displayed in the dynamic characteristics comparison field GP15 in the screen G1 (S310).

In Step S305 and Step S310, the dynamic characteristics refer to characteristics that represent how the state of the control target changes over time when a certain manipulation value is given to the control target in a certain initial state. In process control, the dynamic characteristics are often defined by the time series of the state itself when a time signal such as an impulse signal, a step signal, or a ramp signal is given as a manipulation value, or by the time constants or frequencies thereof, for example. In the present embodiment, the manipulation value in the past manufacturing performance data is input to the process model to calculate the time series of the state, and the difference between the time series of the states is regarded as the distance E[i].

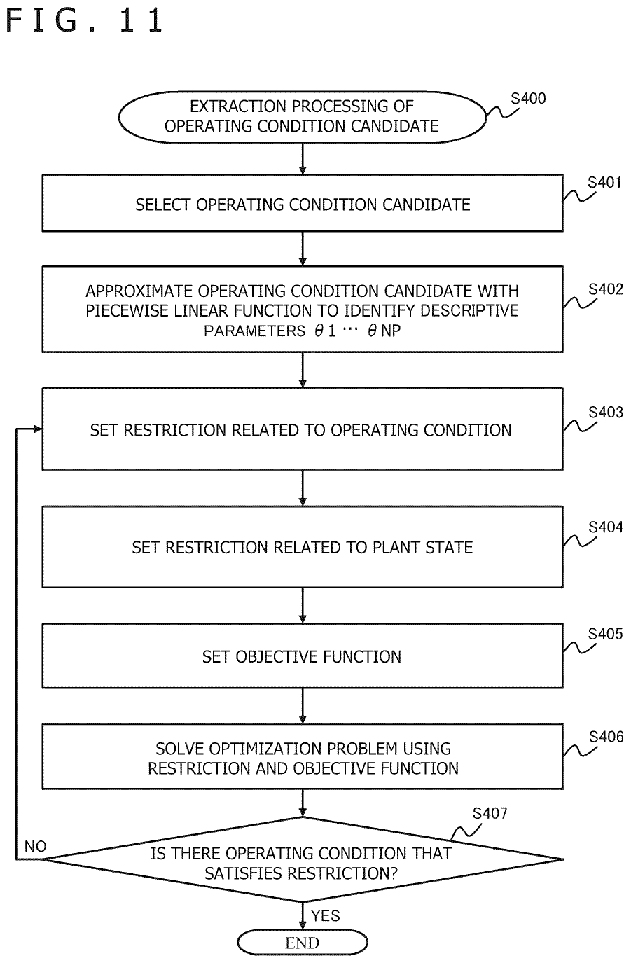

FIG. 10 illustrates the details of Step S305 in FIG. 8. The flowchart of FIG. 10 illustrates the processing procedure for calculation processing of the distance E[i]. Now, this calculation processing is described in accordance with the model of Equation (1).

The operating condition search section 14 acquires the manipulation value of the i-th data from the manufacturing performance database 21 (S3051), inputs the acquired manipulation value to each of the process model Mi and the process model M, and simulates a state Xi and a state X in accordance with Equation (2) (S3052 and S3053). In FIG. 10, Equation (2) is illustrated in Step S3052. Equation (2) is also used in Step S3053.

The operating condition search section 14 calculates the difference between the state Xi obtained in Step S3052 and the state X obtained in Step S3053 in accordance with Equation (3) (S3054).

Here, in Step S3052 and Step S3053, in a case where, as the process model, Equation (1) is considered, for example, the manipulation value is the coolant temperature Tj inside the jacket, and the state Xi and the state X are vectors [θm, θp, and T] including the raw material concentration θm, the product concentration θp, and the reactor internal temperature T. When the coolant temperature Tj inside the jacket is input at each time point and Equation (1) is integrated in the time direction, the values of θm, θp, and T can be obtained. For example, if the values of Tj, θm, θp, and T at discrete time points k are denoted by Tj[k], θm[k], θp[k], and T[k], respectively, the values of θm, θp, and T at each time point can be calculated by repeatedly solving Equation (2), given the series {Tj[0], Tj[1], . . . } and the initial states [θm [0], θp[0], and T[0] ].

In Step S3054, various distance indices can be used for the difference between the state Xi:=[θmi, θpi, Ti] and X:=[θm, θp, T]. In a case where Step S3052 and Step S3053 result in the same simulation time point N, it is only necessary to perform a calculation with the following L2 distance.

Here, ∥·∥ represents the vector norm. On the other hand, in a case where Step S3052 and Step S3053 result in the different simulation time points N, a calculation with the L2 distance as in Equation (3) is not possible. In this case, it is only necessary to construct E[i] using an index such as DTW (Dynamic Time Warping), which enables a comparison of time series with different numbers of samples.

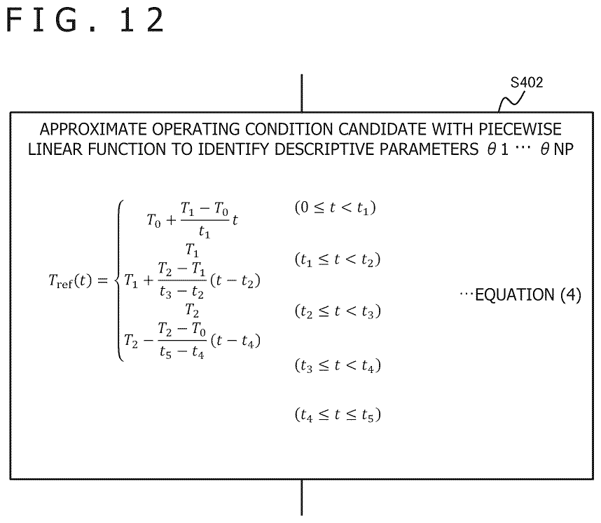

FIG. 11 is a flowchart illustrating the details of Step S400 illustrated in FIG. 7. FIG. 11 illustrates an example of the processing procedure for operating condition search.

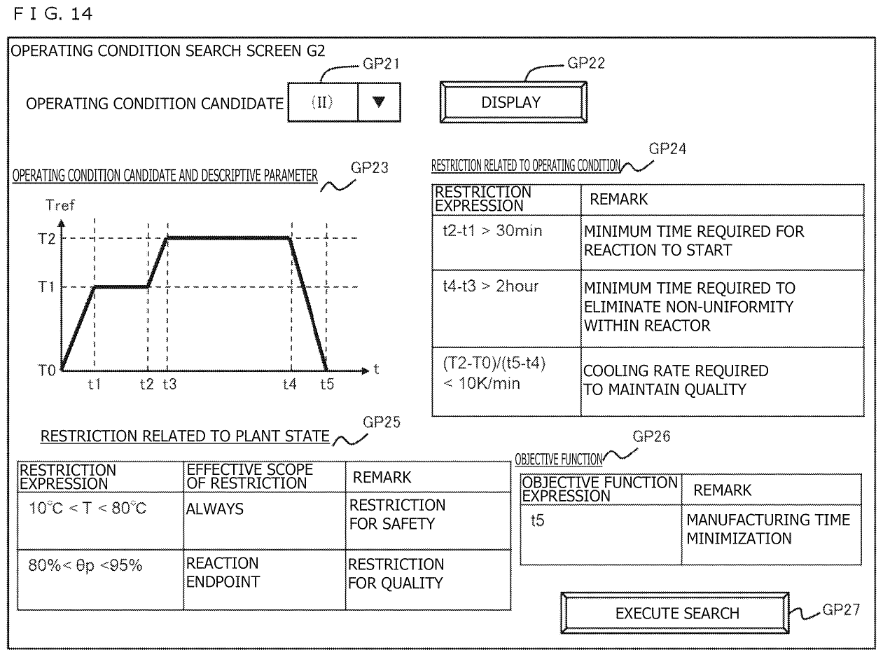

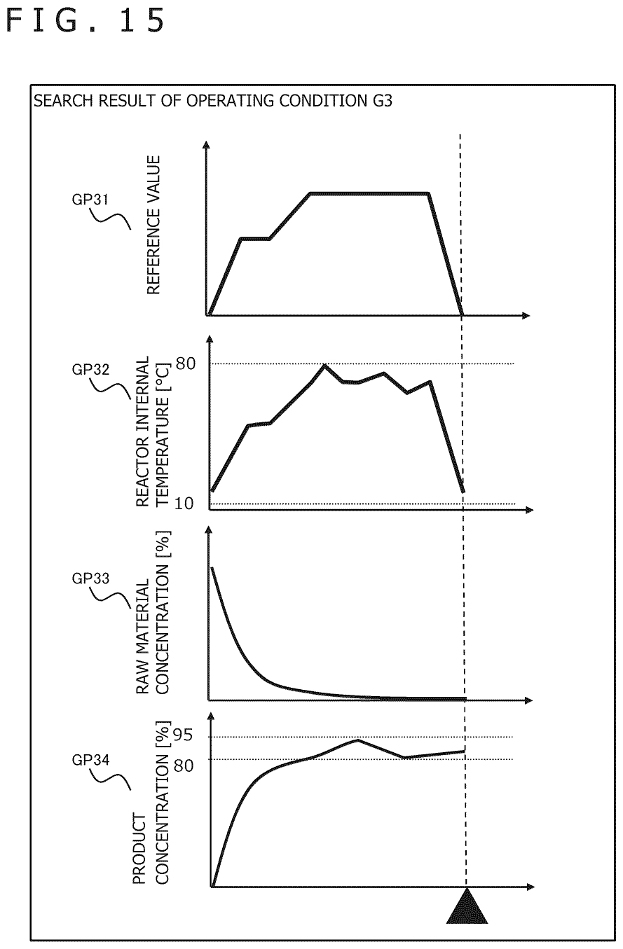

The operating condition search section 14 selects a candidate set of operating conditions to be used for operating condition search (S401). Here, in a case where there are a plurality of candidate sets of operating conditions, the user is allowed to select a candidate set of operating conditions as illustrated in an operating condition candidate selection section GP21 of the operating condition search screen G2 of FIG. 14.

Reference is now made to FIG. 14. FIG. 14 is an example of the operating condition search screen G2 for setting information for searching for operating conditions. The operating condition search screen G2 includes, for example, the field GP21 for selecting candidate sets of operating conditions, a button GP22 for causing the details of candidate sets of operating conditions to be displayed, a field GP23 for displaying candidate sets of operating conditions and descriptive parameters, a field GP24 for setting restrictions related to operating conditions, a field GP25 for setting restrictions related to plant states, a field GP26 for setting objective functions for searching for operating conditions, and a button GP27 used for instruction on the search for operating conditions.

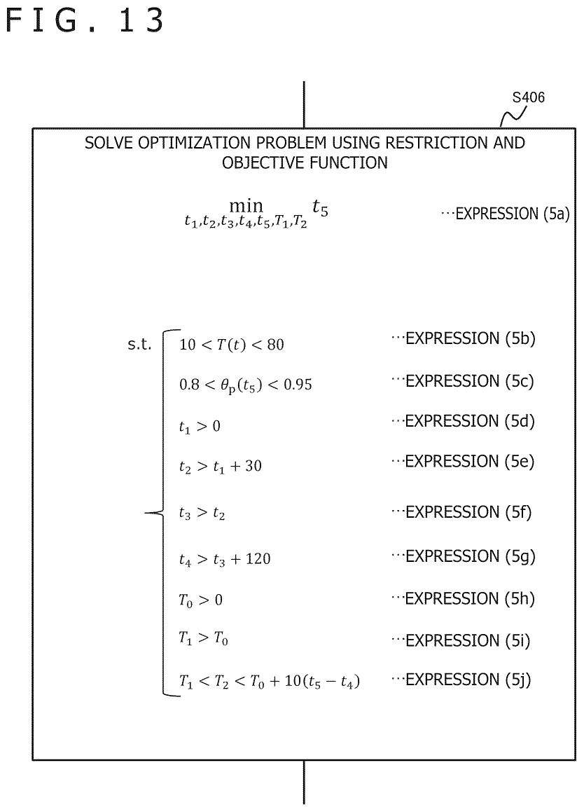

Returning to FIG. 11, when the user presses the display button GP22 in FIG. 14, the operating condition search section 14 approximates the candidate set of operating conditions selected in Step S401 with a piecewise linear function and causes the resultant to be displayed in the field GP23 for displaying candidate sets of operating conditions and descriptive parameters of FIG. 14 (S402). Here, the piecewise linear function approximation is achieved using a curve fitting algorithm such as the least squares method. In the display field GP23, an example is illustrated in which the time series of a reference value Tref of the reactor internal temperature is approximated with the piecewise linear function of Equation (4) illustrated in FIG. 12. FIG. 12 illustrates the details of Step S402 in FIG. 11. FIG. 13 illustrates the details of Step S406 in FIG. 11.

Returning again to FIG. 11, the user inputs restriction conditions related to operating conditions with reference to the result of the piecewise linear approximation of the candidate set of operating conditions (S403). As illustrated in the field GP24 for setting restrictions related to operating conditions of FIG. 14, the user can input restriction conditions based on the parameters at the time when the candidate set of operating conditions is approximated with the piecewise linear function.

Such restrictions related to operating conditions often include know-how for manufacturing products with a certain level of quality or higher, such as the minimum time required for reaction to start, the minimum time required for mixing to become uniform within a reactor, and the cooling rate required to maintain quality. In the present embodiment, such manufacturing know-how can also be set as restriction conditions. Therefore, the process control system 1 of the present embodiment can search for operating conditions suitable for the target process by incorporating on-site manufacturing know-how, and is thus easy to use.

The user inputs restriction conditions related to plant states (S404). Here, as illustrated in the field GP25 for setting restrictions related to plant states of FIG. 14, the user can input restriction conditions related to the control value and state of the plant. For example, in FIG. 14, restriction conditions are set such that, for safety reasons, the reactor internal temperature T is required to always be kept within the range of 10° C. to 80° C., and for quality reasons, the product concentration θp at the reaction endpoint (time point t5) is required to be kept within the range of 80% to 95%.

Moreover, the user sets an objective function for searching for operating conditions (S405). For example, as illustrated in the objective function setting field GP26 of FIG. 14, the user can set the reaction endpoint time point t5 (see the time axis of the field GP23) as an objective function in order to minimize manufacturing time. Note that, in addition to manufacturing time, for example, a function such as product concentration may be set as an objective function related to quality, or a composite KPI considering both manufacturing time and quality may be set as an objective function.

The operating condition search section 14 solves the optimization problem using the restriction conditions set in Step S403 and Step S404 and the objective function set in Step S405, and searches for operating conditions that minimize the objective function while complying with the restriction conditions (S406). In the present embodiment, the optimization problem is formulated by Expression (5) illustrated in the details of Step S406 illustrated in FIG. 13.

Expression (5a) in Step S406 illustrated in FIG. 13 indicates the objective function, and Expression (5b) to Expression (5j) are the restriction conditions. Among the restriction conditions, Expression (5b) and Expression (5c) are restriction conditions set in the field GP25 for setting restrictions related to plant states illustrated in FIG. 14. Expression (5e), Expression (5g), and Expression (5j) are restriction conditions set in the field GP24 for setting restrictions related to operating conditions in FIG. 14. Expression (5d), Expression (5f), Expression (5h), and Expression (5i) are restriction conditions that are obvious from the shape of the time series of a candidate set of operating conditions. The value of the objective function and whether the restriction conditions are satisfied or not can be calculated by performing a closed-loop simulation using the process model and the control law under certain operating conditions. This calculation method can be combined with known optimization methods, such as random search or greedy algorithms, thereby solving the optimization problem.

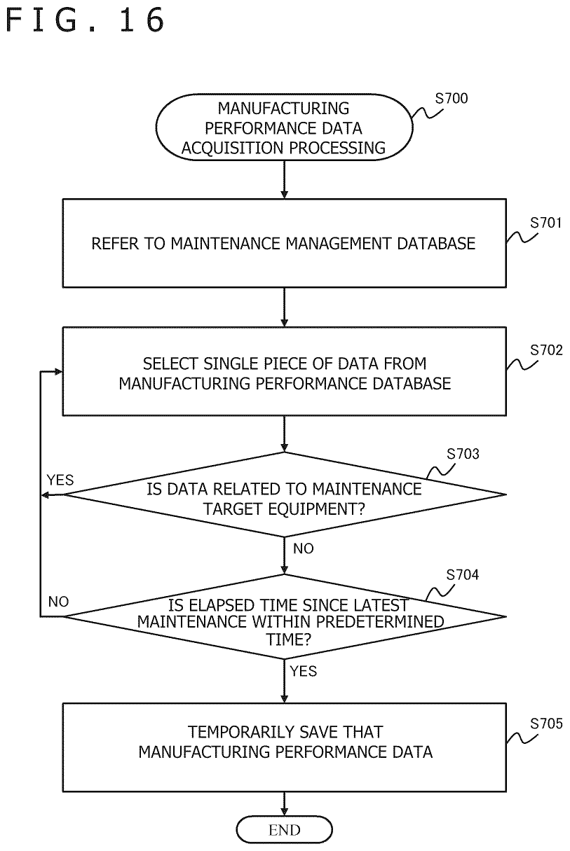

FIG. 15 is an example of the display result of the operating conditions searched for in Step S406 in FIG. 11. Here, the searched operating conditions are displayed in the operating condition display section GP31 to allow the user to confirm the operating conditions. Moreover, under the operating conditions, a closed-loop simulation is performed to calculate the time series of the reactor internal temperature T, the raw material concentration θm, and the product concentration θp. These calculation results are displayed in a reactor internal temperature display section GP32, a raw material concentration display section GP33, and a product concentration display section GP34. Moreover, the restriction conditions related to plant states set in Step S404 are displayed together, thereby allowing the user to confirm that operation that complies with the plant operating restrictions can be performed. The black triangle in FIG. 15 indicates the time point at which the reaction ends.

In the above processing flow, in a case where operating conditions that comply with the operating restrictions are not found, the processing returns to Step S403 to modify the restriction conditions (S407: NO). In a case where operating conditions that comply with the operating restrictions are found (S407: YES), the operating condition search process ends.

As described above, in the process control system described in Embodiment 1, even for a combination of a product type and an equipment type for which there is no manufacturing performance record, performance data having dynamic characteristics closest to those of the control target can be extracted from the manufacturing performance data, and operating conditions can be searched for using the performance data in question as a starting point, thereby achieving plant operation that maximizes KPIS related to quality and manufacturing time while complying with the operating restrictions of the plant.

Note that, in Embodiment 1, the case where the characteristics of the control target change depending on changes in product type and equipment type is assumed. However, for example, even in a case where the characteristics of a control target change due to aging of a plant in a continuous process in the petrochemical field, or in a case where non-steady operation occurs in plant operation due to switching of raw materials, operating conditions can be searched for with the present embodiment.

### Embodiment 2

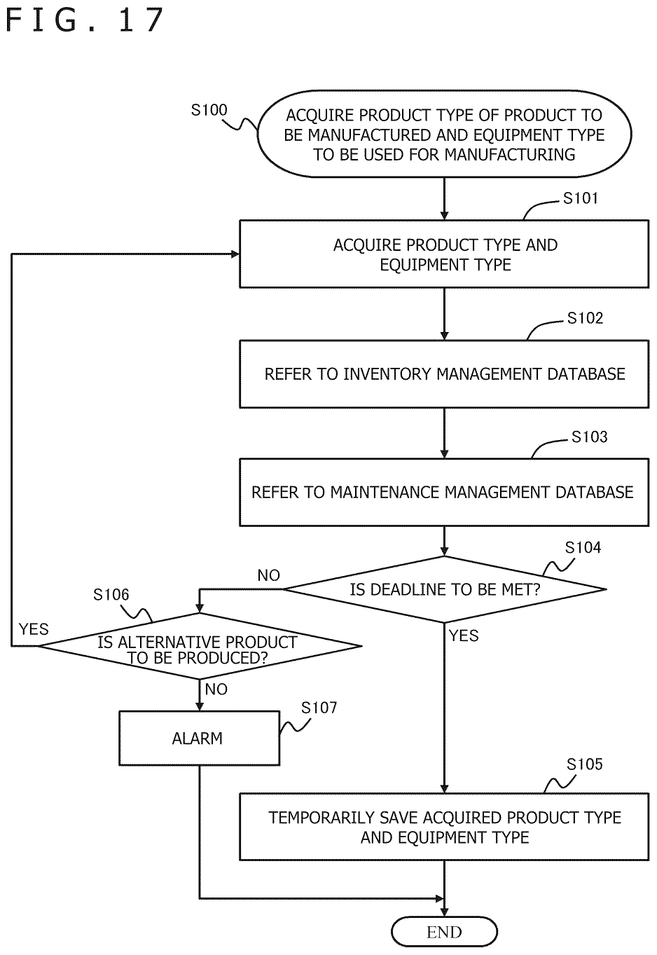

Embodiment 2 is described using FIG. 16. In the following respective embodiments including the present embodiment, differences from Embodiment 1 are mainly described. In the present embodiment, when the manufacturing performance data 21 is read out from the storage section in Step S300 of FIG. 7 and the like, only the manufacturing performance data 21 having predetermined reliability can be extracted.

The processing of acquiring manufacturing performance data in S700 refers to a maintenance management database (S701) and selects the single piece of manufacturing performance data 21 from the manufacturing performance database (S702). The maintenance management database, which is not illustrated, manages the maintenance timing and the like of each equipment type used in the plant.

The operating condition search section 14 determines whether the selected manufacturing performance data is data on maintenance target equipment (S703). If the selected manufacturing performance data is manufacturing performance data on maintenance target equipment (S703: YES), the operating condition search section 14 returns to Step S702 and selects the next single piece of manufacturing performance data. Here, the maintenance target equipment refers to equipment for which maintenance is scheduled in the near future. Since equipment under maintenance cannot be used for manufacturing target products, manufacturing performance data on maintenance target equipment is not used.

If the selected manufacturing performance data is not data on maintenance target equipment (S703: NO), the operating condition search section 14 determines whether the elapsed time since the latest maintenance is within a predetermined time (S704). The operating condition search section 14 extracts manufacturing performance data on an equipment type that has not deteriorated, as the elapsed time since the latest maintenance therefor is short (S704: YES). If the elapsed time since the latest maintenance for the equipment type exceeds the predetermined time (S704: NO), the operating condition search section 14 returns to Step S702 and selects the next single piece of manufacturing performance data.

The operating condition search section 14 temporarily saves the extracted manufacturing performance data (S705). Then, as described above, the temporarily saved manufacturing performance data is used for searching for operating conditions by the operating condition search section 14.

The present embodiment configured as described above also has actions and effects similar to those of Embodiment 1. Moreover, since the operating condition search section 14 of the present embodiment searches for operating conditions using only manufacturing performance data on an equipment type that is not a maintenance target and manufacturing performance data within a predetermined period from the latest maintenance date, operating conditions can be searched for based on practical manufacturing performance data, thereby improving usability.

### Embodiment 3

Embodiment 3 is described using FIG. 17. FIG. 17 is for selecting an alternative combination of a product type and an equipment type in a case where a combination of a product type and an equipment type specified by the user is not suitable for manufacturing.

FIG. 17 is a flowchart of the processing of acquiring the product type of products to be manufactured and an equipment type to be used for manufacturing (S100). When acquiring the product type and equipment type input by the user (S101), the process control system 1 refers to an inventory management database, which is not illustrated (S102), and also refers to the maintenance management database, which is not illustrated (S103). The inventory management database manages the inventory of raw materials to be used for manufacturing products, deadlines, and the like.

In a case where a product is manufactured with the combination of a product type and an equipment type set by the user, the process control system 1 determines whether the user-specified deadline can be met (S104). If the deadline can be met (S104: YES), the process control system 1 temporarily saves the combination of a product type and an equipment type acquired in Step S101 (S105).

If the deadline cannot be met (S104: NO), the process control system 1 determines whether to produce an alternative product (S106). If the user approves the manufacturing of an alternative product (S106: YES), the process control system 1 returns to Step S101 and acquires a combination of a product type and an equipment type for the alternative product (S101). If the user does not approve the manufacturing of an alternative product (S106: NO), the process control system 1 outputs an alarm (S107). That alarm may include information indicating that the specified combination of a product type and an equipment type cannot meet the specified deadline. The product type and equipment type of the alternative product may be explicitly specified by the user, or may be automatically generated by the process control system 1 using a machine learning model.

The present embodiment configured as described above also has actions and effects similar to those of Embodiment 2. Moreover, in the present embodiment, in a case where a combination of a product type and an equipment type specified by the user cannot meet the deadline, the manufacturing of an alternative product can be proposed, thereby improving usability. The present embodiment can also be combined with Embodiment 2.

The present disclosure is not limited to the above-mentioned embodiments as they are, and at the implementation stage, the components can be modified and embodied within the range not departing from the gist thereof, or a plurality of components disclosed in the above-mentioned embodiments can be appropriately combined and implemented.

The present disclosure is described to the extent that the following configurations can be implemented.
(Configuration 1) A process control system that controls a target process by a computer, the process control system including: a process model storage section that stores a process model for predicting a control value from a manipulation value to the process; a manufacturing performance data storage section that stores manufacturing performance data on the process; a process simulation section that performs a simulation of the target process by using the process model acquired from the process model storage section; and an operating condition search section that extracts manufacturing performance data in another process similar to the target process within a predetermined range from the manufacturing performance data storage section, and searches for, based on the manufacturing performance data extracted, an operating condition that satisfies an operating restriction of the target process.
(Configuration 2) The process control system according to Configuration 1, in which the process model storage section stores a process model calculated in advance in accordance with a product type of a manufacturing target and a type of equipment to be used for manufacturing.
(Configuration 3) The process control system according to Configuration 1 or 2, further including a control law storage section that stores a control law of the process, in which the process simulation section executes a closed-loop simulation using the process model acquired from the process model storage section and the control law acquired from the control law storage section, and the operating condition search section searches for the operating condition based on a result of the closed-loop simulation.
(Configuration 4) The process control system according to any one of Configurations 1 to 3, in which the operating condition search section further searches for the operating condition on the basis of a predetermined evaluation index set in a plant.
(Configuration 5) The process control system according to any one of Configurations 1 to 4, in which the operating condition search section calculates a time variation of a state of the target process by using the process model, and extracts manufacturing performance data on another process having a time variation of a state similar to the time variation of the state calculated within a predetermined range.
(Configuration 6) The process control system according to any one of Configurations 1 to 5, in which the operating condition search section calculates a time variation of an internal state of the process as the time variation of the state without using actual measurement data.
(Configuration 7) The process control system according to any one of Configurations 1 to 6, in which the process model storage section stores a process model calculated in advance in accordance with a product type of a manufacturing target and a type of equipment to be used for manufacturing, the manufacturing performance data storage section executes storing in accordance with the product type of the manufacturing target and the type of the equipment to be used for manufacturing, and the operating condition search section identifies a product type and an equipment type related to another process model having a dynamic characteristic close to a dynamic characteristic of the process model of the target within a predetermined range, and extracts manufacturing performance data corresponding to the product type and the equipment type identified from the manufacturing performance data storage section.
(Configuration 8) The process control system according to any one of Configurations 1 to 7, in which the operating condition search section approximates a candidate of an operating condition that satisfies an operating restriction of the target process with a piecewise linear function, and defines a restriction condition and an objective function to be used in searching for the operating condition, by using a parameter of the piecewise linear function.
(Configuration 9) The process control system according to any one of Configurations 1 to 8, in which the operating restriction is set based on a state actually measured for the target process and an internal state calculated using the process model of the target.
(Configuration 10) The process control system according to any one of Configurations 1 to 9, in which the process is a batch process.
(Configuration 11) The process control system according to any one of Configurations 1 to 10, in which the operating condition search section acquires only manufacturing performance data having predetermined reliability from the manufacturing performance data storage section.
(Configuration 12) The process control system according to any one of Configurations 1 to 11, in which the manufacturing performance data having the predetermined reliability is manufacturing performance data related to an equipment type that is not a maintenance target, and/or manufacturing performance data within a predetermined time from a latest maintenance date.
(Configuration 13) The process control system according to any one of Configurations 1 to 11, in which a product type of a manufacturing target and a type of equipment to be used for manufacturing are selected from among combinations of product types and equipment that can meet a deadline.
(Configuration 14) A process control method for controlling a target process by a computer, the process control method including: storing a process model for predicting a control value from a manipulation value to the process in a process model storage section; storing manufacturing performance data on the process in a manufacturing performance data storage section; executing a simulation of the target process by using the process model acquired from the process model storage section; extracting manufacturing performance data in another process similar to the target process within a predetermined range from the manufacturing performance data storage section; and searching for, on the basis of the manufacturing performance data extracted, an operating condition that satisfies an operating restriction of the target process.

### REFERENCE SIGNS LIST

1: process control system
11: model construction section
12: control law design section
13: simulation section
14: operating condition search section
15: process model (process model storage section)
16: control law (control law storage section)
17: operating condition (operation condition storage section)
18: manufacturing performance recording section
19: user interface section
21: manufacturing performance database
22: characteristic information database
31: control unit, 32: control target

1. A process control system that searches for an operating condition of a target process by a computer, the process control system comprising:
a process model storage section that stores information on a process model that is a model for each characteristic of the process and is a model for predicting a control value from a manipulation value to the process;
a manufacturing performance database that stores manufacturing performance data on the process; and
an operating condition search section that identifies, based on the information on the process model, a characteristic related to the target process and different from a characteristic of the model of the target, extracts manufacturing performance data related to the characteristic identified, and searches for an operating condition of the target process on a basis of the manufacturing performance data extracted.

2. The process control system according to claim 1, wherein
the operating condition search section, when identifying the characteristic related to the target process and different from the characteristic of the model of the target on the basis of the information on the process model, identifies another process model whose dynamic characteristic has a relationship with a dynamic characteristic of the process model of the target process, the relationship satisfying a predetermined condition, thereby identifying a characteristic corresponding to the another process model.

3. The process control system according to claim 1, wherein
the process model is a model for each combination of a product type of a manufacturing target and a type of equipment to be used for manufacturing.

4. The process control system according to claim 3, further comprising:
a control law storage section that stores a control law of the process; and
a process simulation section that performs a simulation of the target process by using the process model acquired from the process model storage section, wherein
the process simulation section executes a closed-loop simulation using the process model acquired from the process model storage section and the control law acquired from the control law storage section, and
the operating condition search section searches for the operating condition on a basis of a result of the closed-loop simulation.

5. The process control system according to claim 4, wherein
the operating condition search section further searches for the operating condition on a basis of a predetermined evaluation index set in a plant.

6. The process control system according to claim 1, wherein
the operating condition search section, when identifying the characteristic related to the target process and different from the characteristic of the model of the target on the basis of the information on the process model, calculates a time variation of a state of the target process by using the process model, thereby identifying a characteristic corresponding to another process model having a time variation of a state similar to the time variation of the state calculated within a predetermined range.

7. The process control system according to claim 6, wherein
the operating condition search section calculates a time variation of an internal state of the process as the time variation of the state of the target process without using actual measurement data.

8. The process control system according to claim 1, wherein
the process model storage section stores a process model calculated in advance in accordance with a product type of a manufacturing target and a type of equipment to be used for manufacturing,
the manufacturing performance database stores the manufacturing performance data in accordance with the product type of the manufacturing target and the type of the equipment to be used for manufacturing, and
the operating condition search section identifies a product type and an equipment type related to another process model having a dynamic characteristic close to a dynamic characteristic of the process model of the target within a predetermined range, and extracts manufacturing performance data corresponding to the product type and the equipment type identified from the manufacturing performance database.

9. The process control system according to claim 1, wherein
the operating condition search section approximates a candidate of an operating condition that satisfies an operating restriction of the target process with a piecewise linear function, and defines a restriction condition and an objective function to be used in searching for the operating condition, by using a parameter of the piecewise linear function.

10. The process control system according to claim 1, wherein
the operating restriction is set based on a state actually measured for the target process and an internal state calculated using the process model of the target.

11. The process control system according to claim 1, wherein
the process is a batch process.

12. A process control system that searches for an operating condition of a target process by a computer, the process control system comprising:
a process model storage section that stores information on a process model that is a model for each of a plurality of processes with different characteristics and is a model that predicts a control value from a manipulation value to a corresponding one of the processes;
a manufacturing performance database that stores manufacturing performance data on the processes; and
an operating condition search section that identifies, based on the information on the process model, another process related to the target process, extracts manufacturing performance data in the another process identified, and searches for an operating condition of the target process on a basis of the manufacturing performance data extracted in the another process.

13. The process control system according to claim 12, wherein
the process model is a model created for each characteristic of the process, and
the another process is a process with a characteristic different from a characteristic of the target process.

14. A process control method for searching for an operating condition of a target process by a computer, the process control method comprising:
a step of acquiring, among information on a process model that is a model for each characteristic of the process and is a model that predicts a control value from a manipulation value to the process, information on the process model of the target process;
a step of identifying, based on the information on the process model, a characteristic related to the target process and different from a characteristic of the model of the target,
a step of extracting manufacturing performance data related to the characteristic identified, among manufacturing performance data on the process, and
a step of searching for an operating condition of the target process on a basis of the manufacturing performance data extracted.
